(19) United States
(12) Patent Application Publication
(10) Pub. No.: US 2014/0309121 A1
(43) Pub. Date: Oct. 16, 2014

(54) Categorisation Of Biological Deposits Using Matrix Assisted Laser Desorption Ionisation Mass Spectrometry

(71) Applicant: SHEFFIELD HALLAM UNIVERSITY, South Yorkshire (GB)

(72) Inventors: Simona Francese, Sheffield South Yorkshire (GB); Leesa Susanne Ferguson, Cambridge (GB); Rosalind Wolstenholme, Sheffield South Yorkshire (GB); Florian Wulfert, Sheffield South Yorkshire (GB); Judith Marlou Fonville, Cambridge (GB)

(21) Appl. No.: 14/240,086

(22) PCT Filed: Jul. 24, 2012
(86) PCT No.: PCT/GB2012/051775

§ 371 Date: Jun. 30, 2014

(30) Foreign Application Priority Data
Aug. 23, 2011 (GB) 1114573.7
Nov. 29, 2011 (GB) 1120533.3

(51) Int. Cl. G01N 27/64

(52) U.S. Cl. CPC G01N 27/64
USPC 506/8; 506/39

(57) ABSTRACT

A method of categorising a human according to pre-determined categories using Matrix Assisted Laser Desorption Ionisation Mass Spectrometry (MALDI-MS) is disclosed. A method is provided to discriminate humans based on gender, for example, by comparing MALDI-MS sample spectral data in the m/z range 2,000 to 30,000 and comparing these sample spectral data with reference spectral data obtained from pre-categorised humans.

The present invention relates to method and apparatus for categorising a human according to pre-determined categories using MALDI-MS.

It has been shown recently that Matrix Assisted Laser Desorption Ionisation Mass Spectrometry (MALDI MS) is suitable to detect and image a variety of endogenous biomolecules and exogenous compounds from biological deposits and in particular latent fingermarks. This discovery has a number of potential applications one of which is to assist with criminal investigations by providing investigators with both an image for suspect identification and chemical information to be used as additional intelligence. The latter becomes particularly important when the latent fingermark is distorted or smudged or when the suspect is not a previously convicted offender and therefore his/her fingerprints are not present in a database.

Latent fingermarks are the result of material from the surface of the skin transferring to another surface on contact. Latent fingermarks consist of the sweat from the eccrine and sebaceous glands. Sebaceous secretions consist of primarily fat soluble organic compounds such as fatty acids, sterols, squalene, glycerides and wax esters. Eccrine secretions consist of 98% water, but also contain both inorganic and water soluble organic species such as urea, amino acids and proteins [A. M Knowles (1978). Aspects ofphysicochemical methods for detection of latent fingerprints, Journal of physics E-scientific instruments 11 (8) (1978) 713-721]; [R. S. Ramotowski, Composition of latent print residue, in: H. C. Lee, R. E. Gaensslen (Eds.), Advances in fingerprint technology, CRC Press, Boca Raton, London, New York, Washington D.C., 2001, pp. 63-104].

Many techniques are currently available that allow the enhancement and recovery of fingermarks left at a crime scene. Recovered fingermarks are not always of an adequate quality suitable for suspect identification; they are in fact often smudged or distorted due to the fact that objects are not always touched in a static manner. Despite the variety of available physical and chemical methods for detecting latent fingermarks, the need to discover alternative, more efficient methodologies still remains. Recently various analytical techniques have demonstrated the capability of providing additional chemical information about a fingermark, which can potentially impart details about the donor's dietary habits or drug use, even if the fingermark is unsuitable for comparison [J. S. Day, H. G. M. Edwards, S. A. Dobrowski and A. M. Voice, The detection of drugs of abuse in fingerprints using raman spectroscopy I: Latent fingerprints, Spectrochimica acta part A-molecular and biomolecular spectroscopy 60 (3) (2004) 563-568]; [IS. Day, H. G. M. Edwards, S. A. Dobrowski and A. M. Voice, The detection of drugs of abuse in fingerprints using raman spectroscopy II: Cyanoacrylate fumed fingerprints. Spectrochimica acta part A-molecular and biomolecular spectroscopy 60 (8-9) (2004) 1725-1730]; [C. Ricci, P. Phiriyavityopas, N. Curum, K. L. Chan, S. Jickells and S. G. Kazarian, Chemical imaging of latent fingerprint residues, Applied spectroscopy 61 (5) (2007) 514-522]; [C. Ricci, S. Bleay and S. G. Kazarian, Spectroscopic imaging of latent fingermarks collected with the aid of a gelatin tape, Analytical chemistry, 79 (15) (2007) 5771-5776]; [D. R. Ifa, N. E. Manicke, A. L. Dill and R. G. Cooks, Latent fingerprint chemical imaging by mass spectrometry, Science 321 (5890) (2008) 805]; [R. Wolstenholme, R. Bradshaw, M. R. Clench and S. Francese (2009). Study of latent fingermarks by matrix-assisted laser desorption/ionisation mass spectrometry imaging of endogenous lipids, Rapid communications in mass spectrometry, Rapid Communications in Mass Spectrometry 23 (2009) 3031-3039]; [R. Bradshaw, R. Wolstenholme, R. D. Blackledge, M. R. Clench, L. S. Ferguson and S. Francese, A novel matrix-assisted laser desorption/ionisation mass spectrometry imaging based methodology for the identification of sexual assault suspects Rapid Commun. Mass Spectrom. 2011, 25, 415-422]; [L. Ferguson, R. Bradshaw, R. Wolstenholme, M Clench and S. Francese, Two-Step Matrix Application for the Enhancement and Imaging of Latent Fingermarks, Analytical Chemistry, in press]; [M V. Buchanan, K Asano and A. Bohanon, Chemical characterization of fingerprints from adults and children, SPIE 2941 (1997) 89-95].

The ability to detect the chemical constituents of fingermarks has led to various research groups attempting to discriminate between the fingermarks of individuals based on the endogenous biomarkers present. This type of information could potentially be used to create a profile of the donor, which could be valuable for reducing the pool of potential suspects in criminal investigations. In one study, gas chromatography-mass spectrometry (GC-MS) was employed to differentiate between the chemical composition of adult's and children's fingermarks [M V. Buchanan, K Asano and A. Bohanon, Chemical characterization of fingerprints from adults and children, SPIE 2941 (1997) 89-95]. The study found the fingermark residues of children differed from those obtained from adults in the quantity of various sebaceous species such as fatty acids, cholesterol, squalene and wax esters). More recently Fourier transform infrared microscopy (FTIRM) enabled adults' groomed fingermarks (fingermarks artificially loaded with sebaceous content) to be distinguished from children up to 4 weeks after deposition based on variations in the sebaceous material present [K M Antoine, S. Mortazavi, A. D. Miller and L. M. Miller, Chemical differences are observed in children's versus adults' latent fingerprints as a function of time, Journal of forensic sciences 55 (2) (2010) 513-518].

Differences in the sebaceous content of fingermarks obtained from individuals of a similar age have also been investigated. In a recent study, Weyermann and collaborators used GC-MS to investigate the initial composition of fingermarks in both inter-donor and intra-donor variability studies [C. Weyermann, C. Roux and C. Champod, Initial results on the composition of fingerprints and its evolution as a function of time by GC/MS analysis, Journal of forensic sciences, 56 (1) (2011) 102-108]. In the inter-donor variability study, six donors (three female and three male) deposited groomed fingermarks onto five different substrates. Squalene and cholesterol were identified in all donors' fingermarks, as well as other sebaceous compounds such as wax esters and fatty acids. The composition of the donated fingermarks was found to vary substantially between different donors, as well as those fingermarks obtained from one donor (intra-donor study). The results of this investigation support the findings of previous similar studies [Y S. Dikshitula, L. Prasad, J. N. Pal and C. V. Rao, Aging studies on fingerprint residues using thin-layer and high performance liquid chromatography, Forensic science international 31 (4) (1986) 261-266]; [N. E. Archer, Y. Charles, J. A. Elliott and S. Jickells, Changes in the lipid composition of latent fingerprint residue with time after deposition on a surface, Forensic science international, 154 (2-3) (2005) 224-239].

The influence of gender on the chemical composition of fingermark residues has also been investigated by various research groups. Asano and collaborators attempted to discriminate between genders using GC-MS and by looking at possible fatty acids markers. Besides being a destructive technique, this approach yielded a possible gender discrimination using three fatty acids in the pilot study, but no classification in a larger and statistically designed experiment [K G. Asano, C. K. Bayne, K. M. Horsman and M V. Buchanan, Chemical composition of fingerprints for gender determination, Journal of forensic sciences, 47 (4) (2002) 805-807]. More recently, Laser Desorption/Ionisation (LDI) Time of Flight Mass Spectrometry (TOF M S) has been employed in a gender comparison study [B. Emerson, J. Gidden, J. O. Lay and B. Durham, Laser Desorption/Ionization time-of-flight mass spectrometry of triacylglycerols and other components in fingermark samples, Journal of forensic sciences 56 (2) (2011) 381-389]. Groomed fingermarks were collected from 16 donors (8 female and 8 male) in order to establish whether any discrimination could be made on the basis of the presence in the fingermarks of triacylglycerols (TAGs) and other sebaceous constituents. Two TAGs were found to be significant for gender discrimination at the 95% of confidence level and two others at 97.5%; however, as the TAGs differences were found to be very often close to the standard deviation of the measurements, the authors concluded that no real specificity was achieved and LDI TOF MS was not a reliable technology to determine gender from fingermarks.

In a completely different approach described in WO 00/46739 by Zelson [A. S. Zelson, Fingerprint analysis method International Publication number WO 00/46739 (2000)] the ridge width measurement, independent from body size, has been proven to correlate to gender. The method bases its probable discrimination of the gender on the width measurements of two to ten parallel ridges (preferably 10) within the fingermark of interest. The approach used discriminant analysis (the name of which was not reported) by which, remarkably, 94.4% of the randomly selected group of males and females were correctly classified according to sex, whereas a 94.8% of the validation group was correctly classified. These results were obtained using a formula including an average from the ten finger measurements for each donor. Results from test samples using a subset of the donors' cohort showed that, if a random fingermark from an unknown donor is examined, using the formula created for ten fingerprints, it would be possible to predict the gender of the individual with an accuracy between 76% and 100% of the time for females with an average correct classification of 87% and the reported accuracy was between 57% and 100% with an average correct classification of 82% for males. The level of confidence offered by this approach is very high, but does rely heavily on the possibility of retrieving and measuring the width of ten parallel ridges which might not be possible if the fingermark is heavily smudged or distorted.

MALDI MSI has recently been employed to tentatively identify and image the distribution of various endogenous biomolecules such as amino acids, lipids, diacylglycerols and triacylglycerols, as well as exogenous contaminants within ungroomed fingermarks [R. Bradshaw, R. Wolstenholme, R. D. Blackledge, M. R. Clench, L. S. Ferguson and S. Francese, A novel matrix-assisted laser desorption/ionisation mass spectrometry imaging based methodology for the identification of sexual assault suspects Rapid Commun. Mass Spectrom. 2011, 25, 415-422].

However, there exists a need for improvements in the analysis of biological deposits, such as fingermarks, to provide additional information and intelligence that could be used to discriminate and categorise an individual.

Accordingly, the present method and apparatus may be used to detect and/or analyse a variety of biomolecules within the biological deposit to categorise the human depositor and provide useful information that could then be useful to other groups of individuals. Where the biological deposit is a fingermark, the present method and apparatus addresses the problems of smudged, distorted and generally low quality fingermark images as the present technology is insensitive to such factors. The present method and apparatus provides information on the molecular composition of the fingermark that could then be used to provide additional intelligence to investigators and for use in legal enforcement process.

According to a first aspect of the present invention there is provided a method of categorising a human according to predetermined categories using MALDI-MS, the method comprising: obtaining a biological deposit from a human; analysing the deposit using MALDI-MS to obtain sample spectral data in the m/z range 2,000 to 30,000; referencing reference spectral data in a library (database) in the m/z range 2,000 to 30,000 or characteristics based on said reference spectral data obtained from biological deposits from humans that had been analysed using MALDI-MS and categorised into the pre-determined category; comparing characteristics of the sample spectral data with the reference spectral data or characteristics thereon; and characterising the human into at least one of the predetermined categories.

Optionally, the biological deposit comprises a fingermark. Preferably, the fingermark is a fingermark comprising compounds from the eccrine gland and/or sebaceous glands. Preferably, the fingermark is an ungroomed fingermark.

Where the deposit is a fingermark, preferably, the sample spectral data in the m/z range 2,000 to 30,000 comprises peptides, proteins and/or truncated proteins. In particular, the peptides, proteins and/or truncated proteins are endogenous to the human. Alternatively, the present invention is suitable for analysing and detecting exogenous species and even non-biological species, for example, where an individual has come into contact with a chemical and residues of this chemical have been deposited together with the biological deposit. Preferably, the peptides are associated with a sweat gland of the human.

Optionally, where the deposit is a fingermark, the step of analysing the deposit comprises obtaining sample spectral data of peptides in the m/z range 2,000 to 5,000.

Optionally, where the deposit is a fingermark, the step of analysing the deposit comprises obtaining sample spectral data of proteins in the m/z range 5,000 to 30,000.

The present method and apparatus may use one or a plurality of characteristics of the MALDI-MS spectral data in the analysis to categorise the human. Such characteristics may be gleaned directly from the spectral data or may be a result of processing and multivariate analysis of the characteristics of the spectral data including, in particular, individual intensities and m/z values of the peptide and protein species. Preferably, the characteristics comprise any one or a combination of the following set of: individual intensities of spectral peaks of the sample spectral data; a ratio of intensities of spectral peaks of the sample spectral data.

The characteristics may be compiled by analysing all intensity peaks within the m/z range investigated so as to build the reference statistical model based on the reference spectral data for use in analysing the sample spectral data obtained from the human to be categorised. Alternatively, discrete peaks within the m/z range may be identified and used with remaining peaks being unselected. Alternatively, identified peaks may be weighted with greater significance when building the reference spectral data model. In particular, the present invention may comprise manually or automatically identifying biological species (m/z peaks) detected within the MALDI-MS spectral data as being significant markers for categorisation of the human into the pre-determined categories. The mass spectrometry characteristics of these species may then be used to compile the sample spectral data and/or the reference spectral data.

The present invention is suitable to discriminate humans according to a variety of different categories. Optionally, the categories may comprise any one or a combination of the following set of gender; ethnicity; age; health status; dietary habits; humans who smoke; humans that drink excessive alcohol; pregnant females.

According to a second aspect of the present invention there is provided a method of preparing reference spectral data using MALDI-MS for use in the categorisation of a human according to pre-determined categories, the method comprising: categorising a plurality of humans into at least one category of a plurality of predetermined categories based on personal characteristics of each of the humans; obtaining a biological deposit from each of the humans; analysing the deposit from each of the humans using MALDI-MS to obtain spectral data in the m/z range 2,000 to 30,000; for each human associating characteristics of the spectral data with the personal characteristics of the human to generate reference spectral data for use in the comparison with sample spectral data in the m/z range 2,000 to 30,000 obtained from a biological deposit of a non-categorised human.

According to a third aspect of the present invention there is provided a method of categorising a human according to pre-determined categories using MALDI-MS, the method comprising: obtaining a biological deposit from a human; analysing the deposit using MALDI-MS to obtain sample spectral data in the m/z range 2,000 to 30,000; referencing the reference spectral data according to the present invention; and comparing characteristics of the sample spectral data with the reference spectral data within a library (database) or characteristics thereon to categorise the human into at least one of pre-determined categories.

According to a fourth aspect of the present invention there is provided an apparatus for categorising a human according to pre-determined categories using MALDI-MS, the apparatus comprising: a sample holder for holding a biological deposit from a human; a MALDI-MS mass spectrometer to analyse the deposit using MALDI-MS to obtain sample spectral data in the m/z range 2,000 to 30,000; a storage utility containing reference spectral data in the m/z range 2,000 to 30,000 or data based on said reference spectral data obtained from biological deposits from humans that have been analysed using MALDI-MS and categorised into the pre-determined categories; a processor to process a comparison of the characteristics of the sample spectral data with the reference spectral data or data based thereon; and a user interface to allow a user to interrogate the sample spectral data, the reference spectral data and/or the data resulting from the comparison of the sample and reference spectral data.

A specific implementation of the present invention will now be described, by way of example only, and with reference to the accompanying drawings in which:

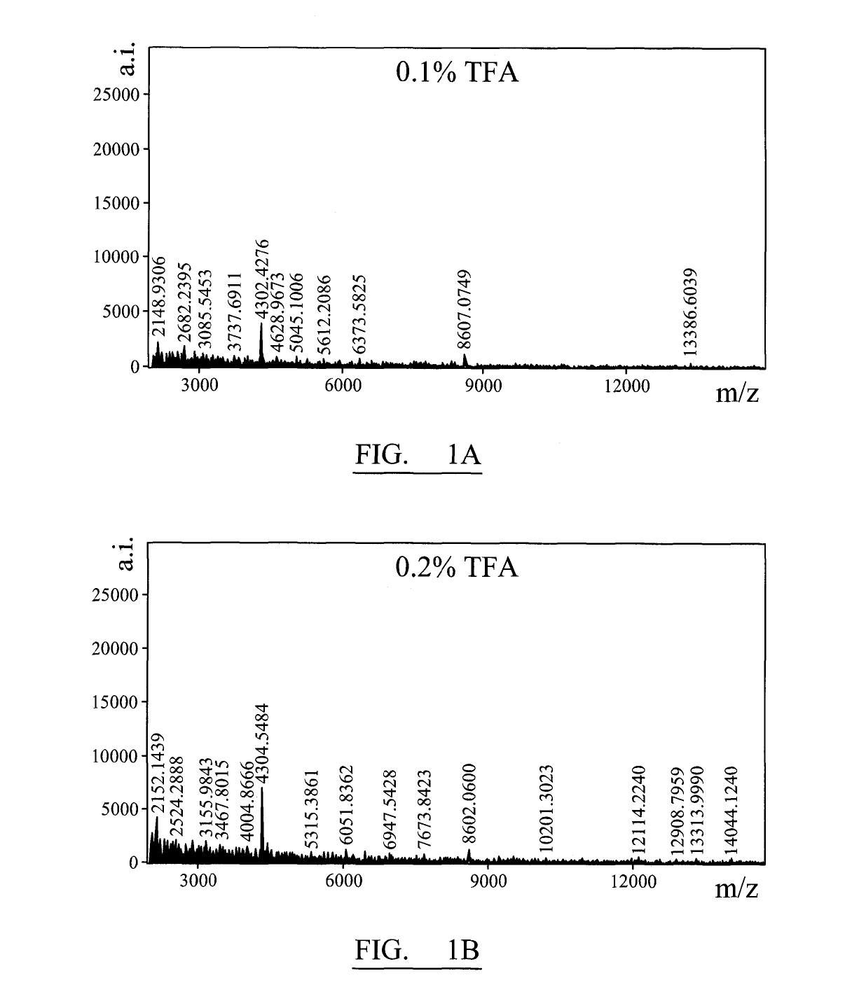

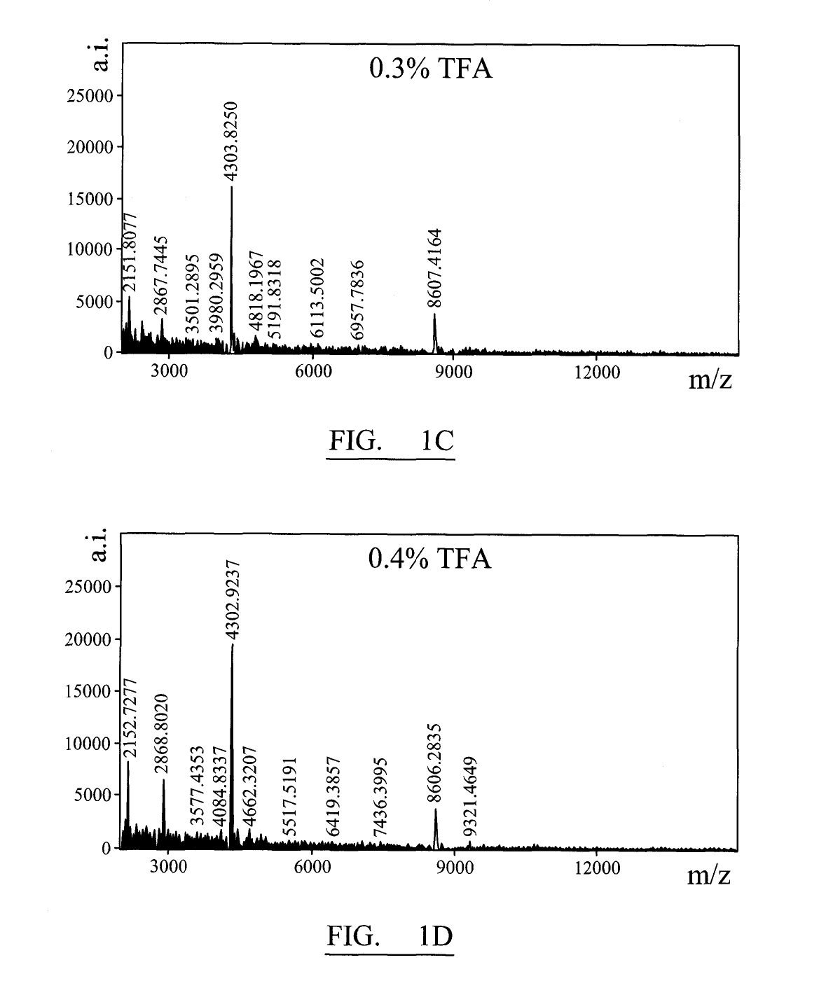

FIG. 1A to 1E are MALDI MS spectra of an ungroomed fingermark spotted with 5 mg/ml of α-CHCA prepared in 70:30 acetonitrile TFA and different concentrations of TFA where FIGS. 1A to 1E display the spectra obtained using TFA v/v percentages of 0.1, 0.2, 0.3, 0.4 and 0.5 respectively;

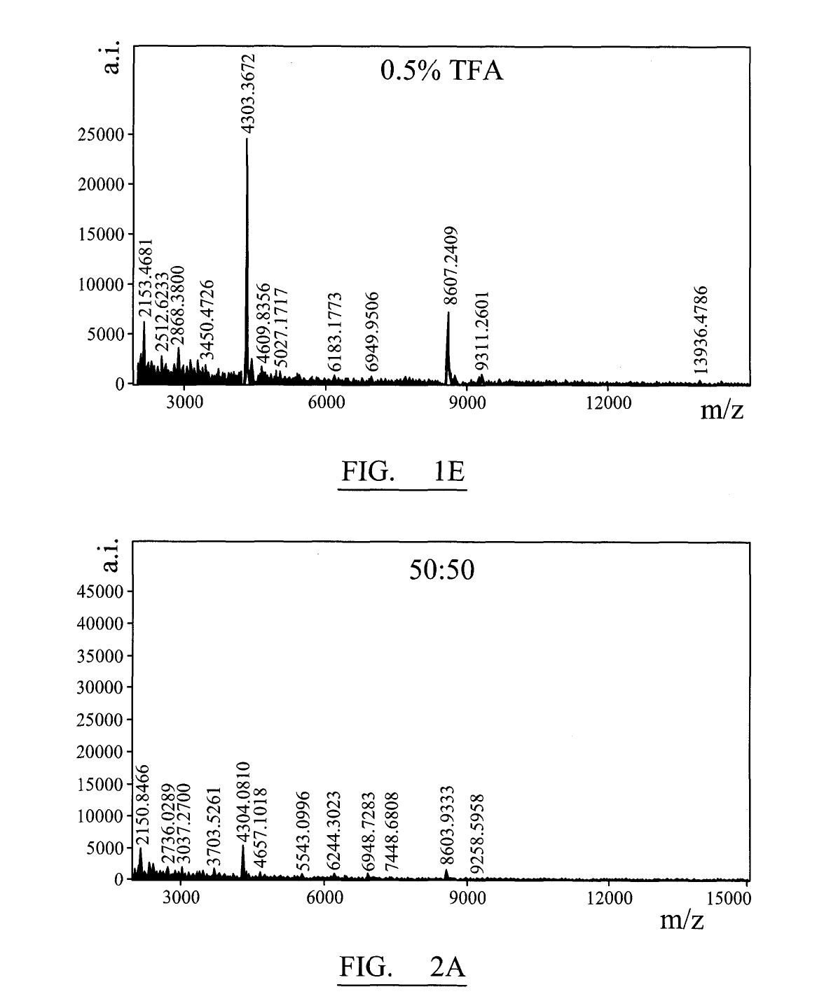

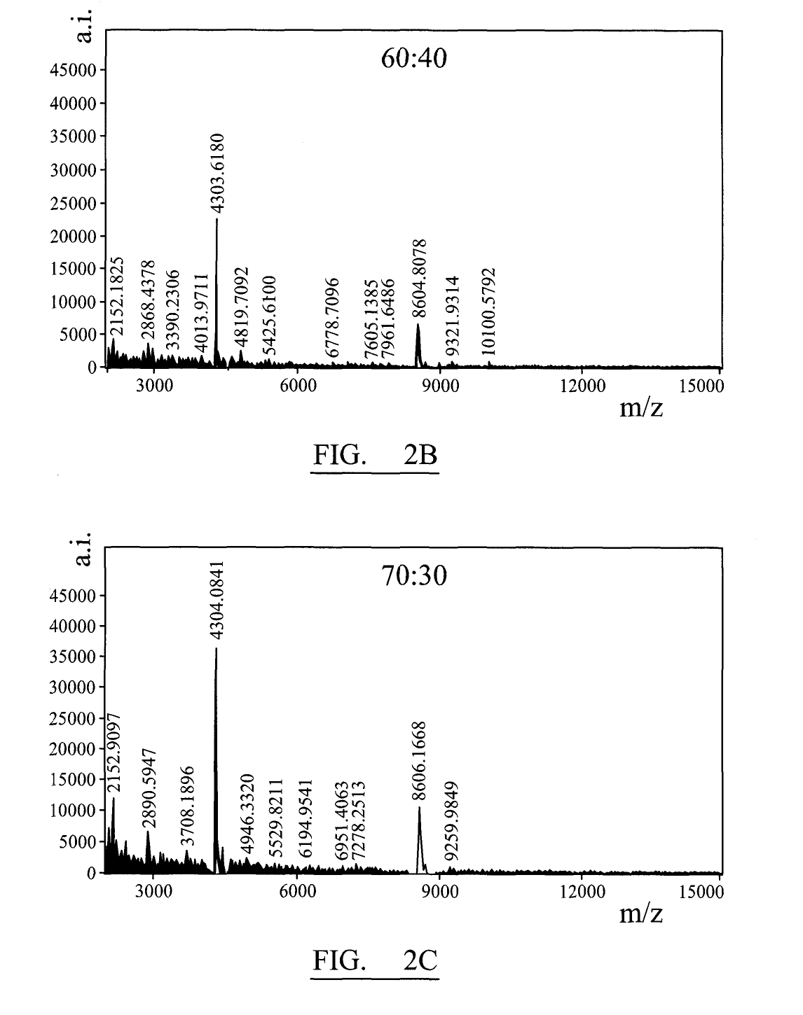

FIG. 2A to 2E are MALDI MS spectra of an ungroomed fingermark spotted with 5 mg/ml of α-CHCA prepared with different ratios of acetonitrile and TFA 0.5% where FIG. 2A to 2E display the spectra obtained using acetonitrile/TFA 0.5% ratios of 50:50, 60:40, 70:30, 80:20 and 90:10 respectively;

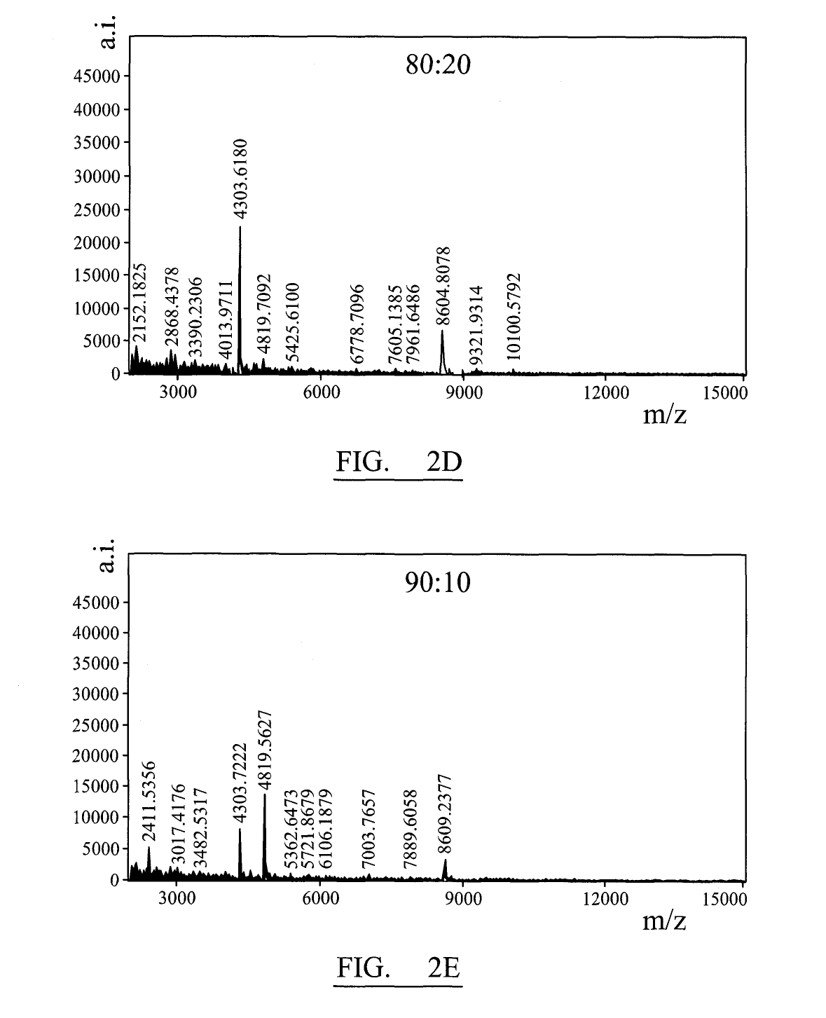

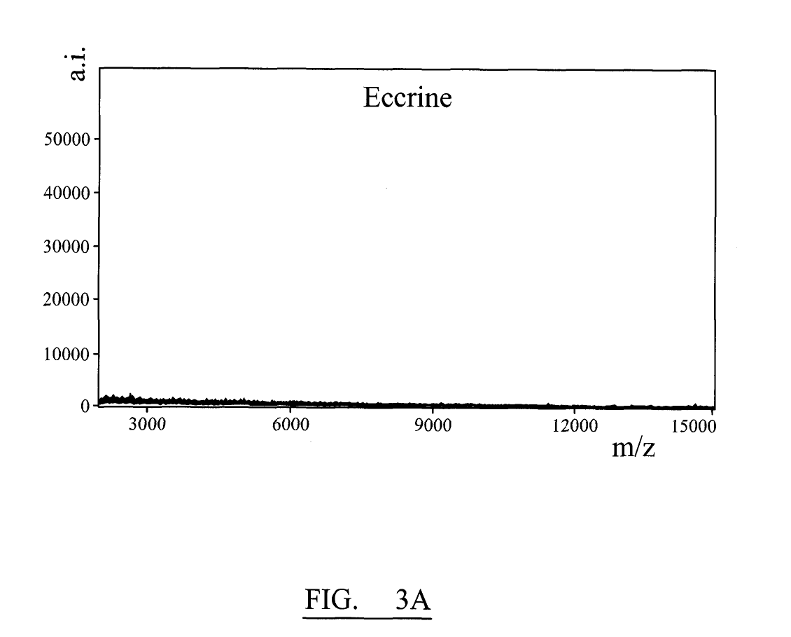

FIG. 3A is a MALDI TOF MS spectrum of an eccrine fingermark;

FIG. 3B is a MALDI TOF MS spectrum of a groomed fingermark;

FIG. 3C is a MALDI TOF MS spectrum of a ungroomed fingermark;

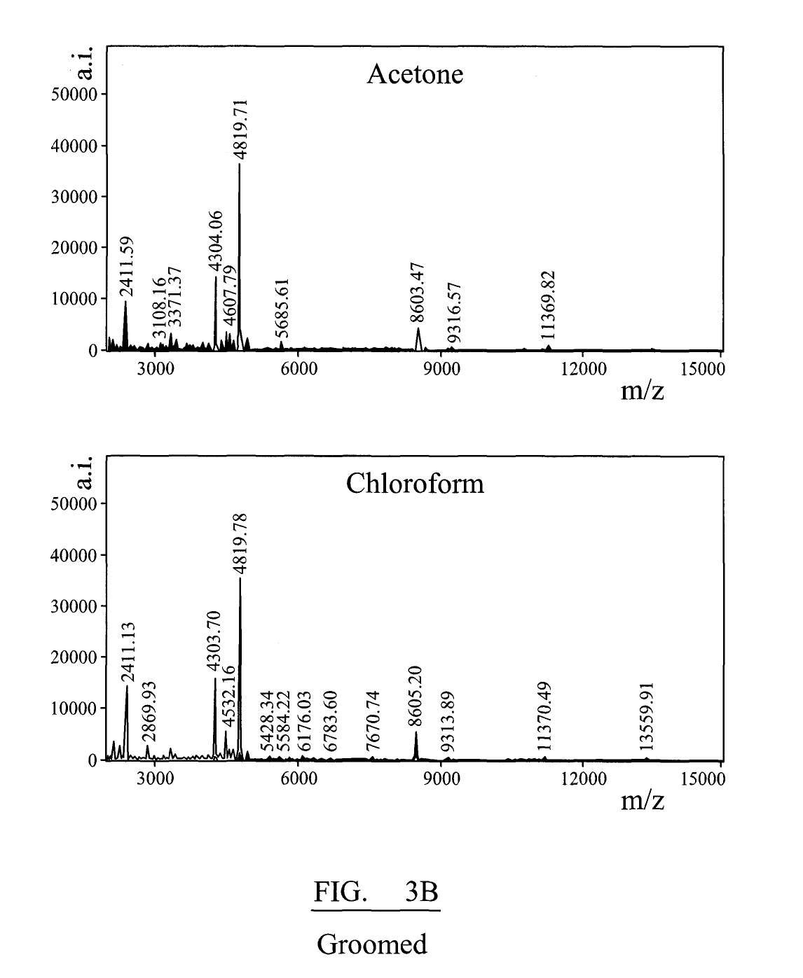

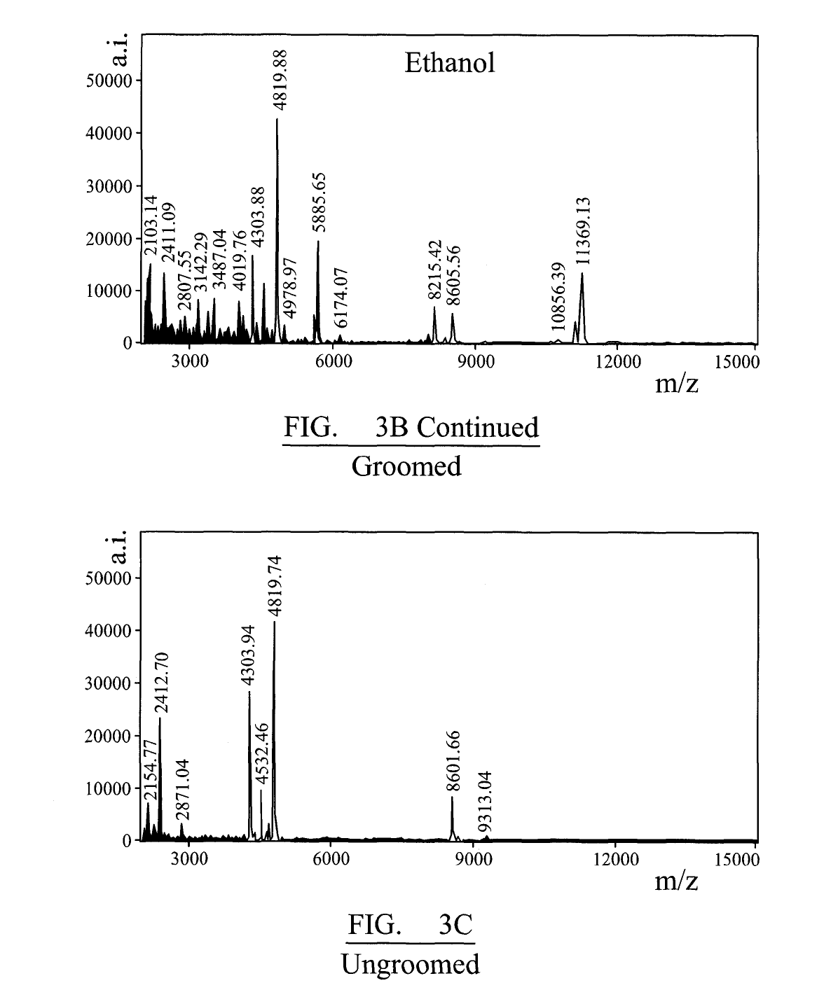

FIG. 4 is box-and whisker plot indicating the median and the lower and upper quartile values showing the prediction performance of a model to categorise deposits;

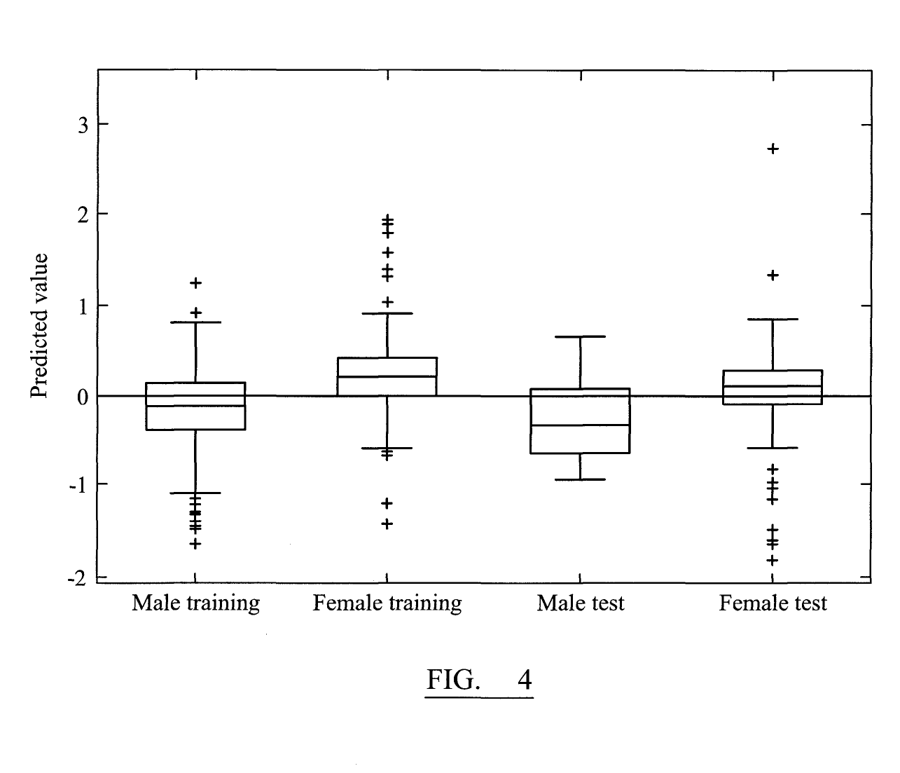

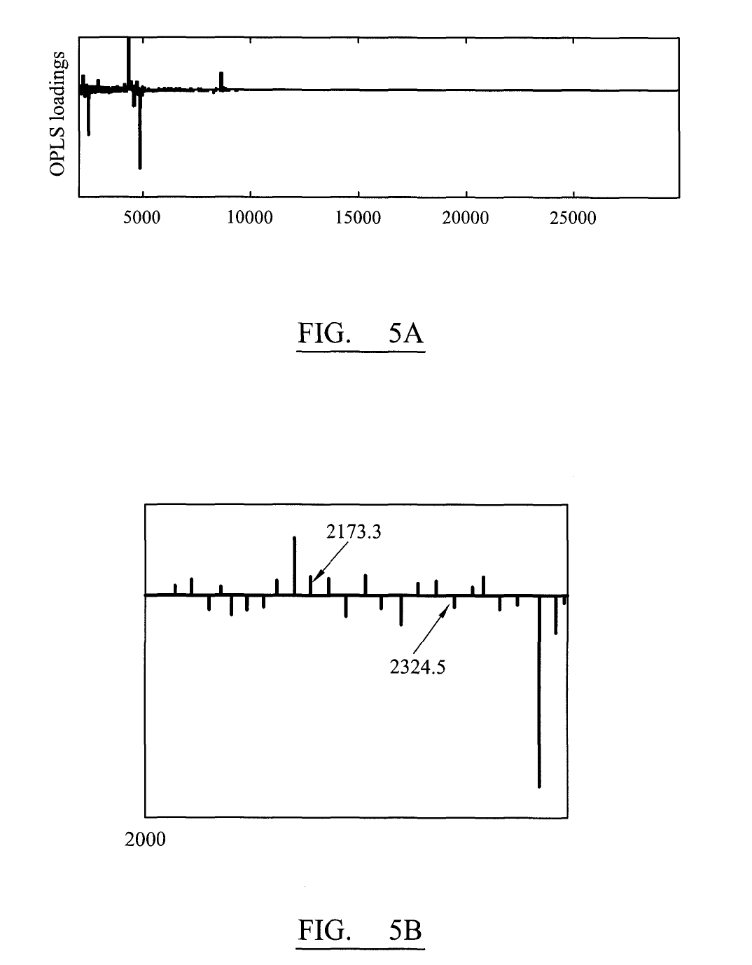

FIG. 5A to 5G are O-PLS-DA loading plots showing the weights of the variables in the classification model, where FIGS. 5B to 5G show magnified regions of FIG. 5A;

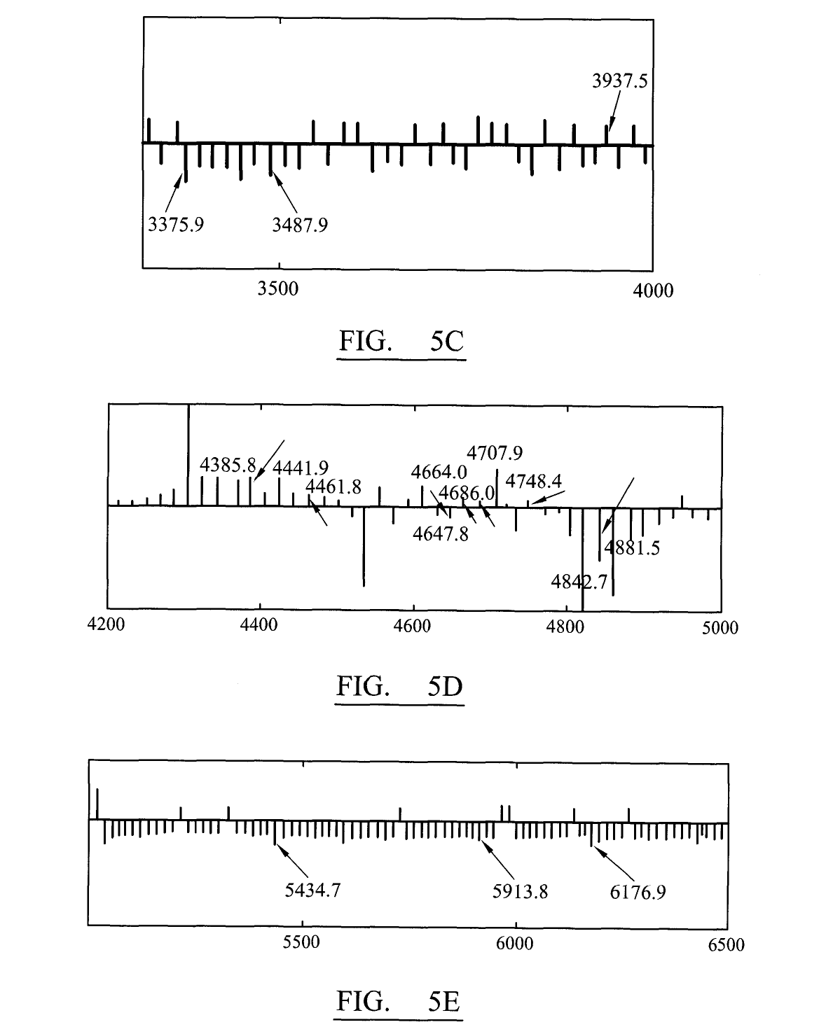

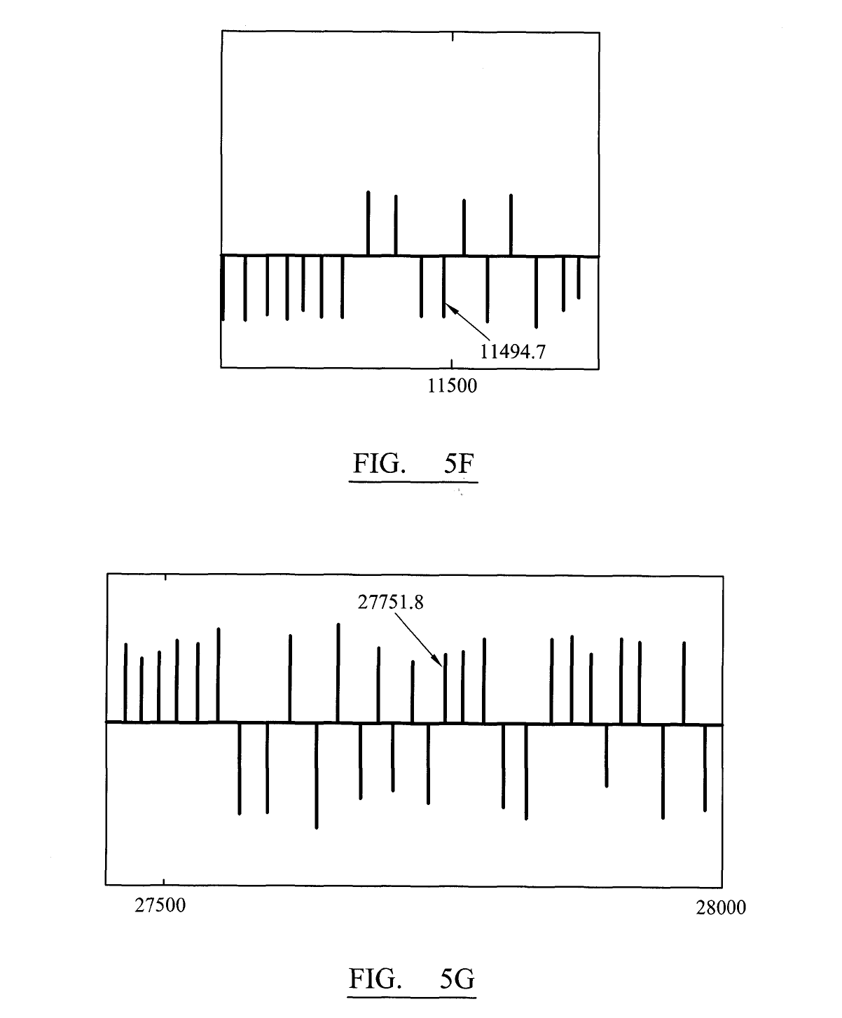

FIGS. 6A and 6B are MALDI MS spectra of ungroomed fingermarks of two individuals of a cohort of 32 participants and illustrate the putative presence of antimicrobial species in fingermarks;

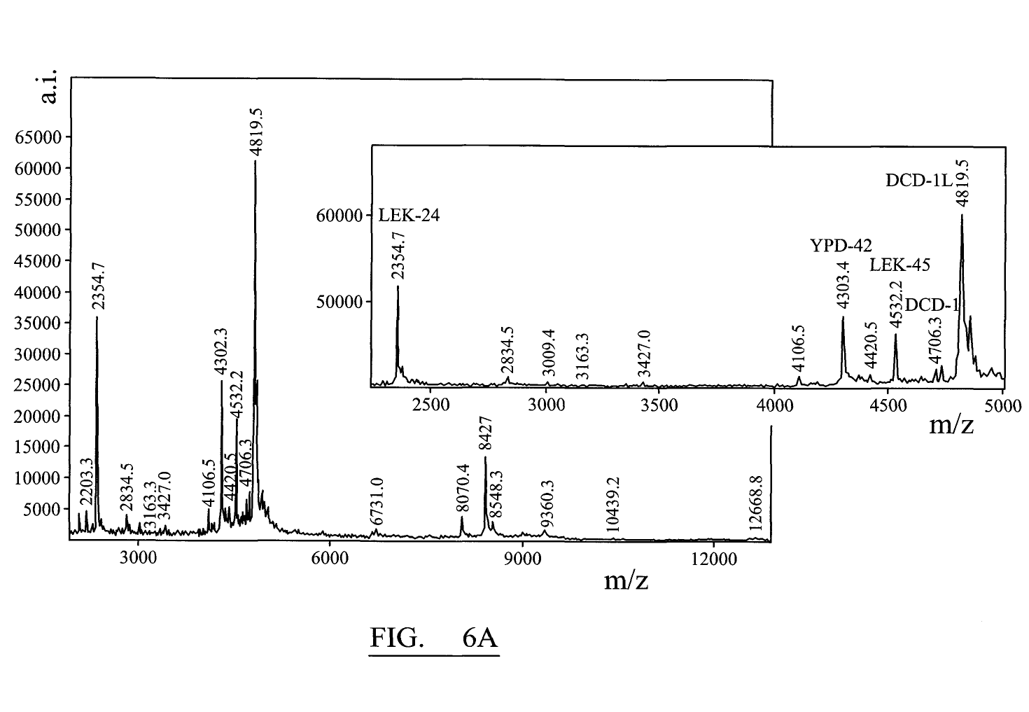

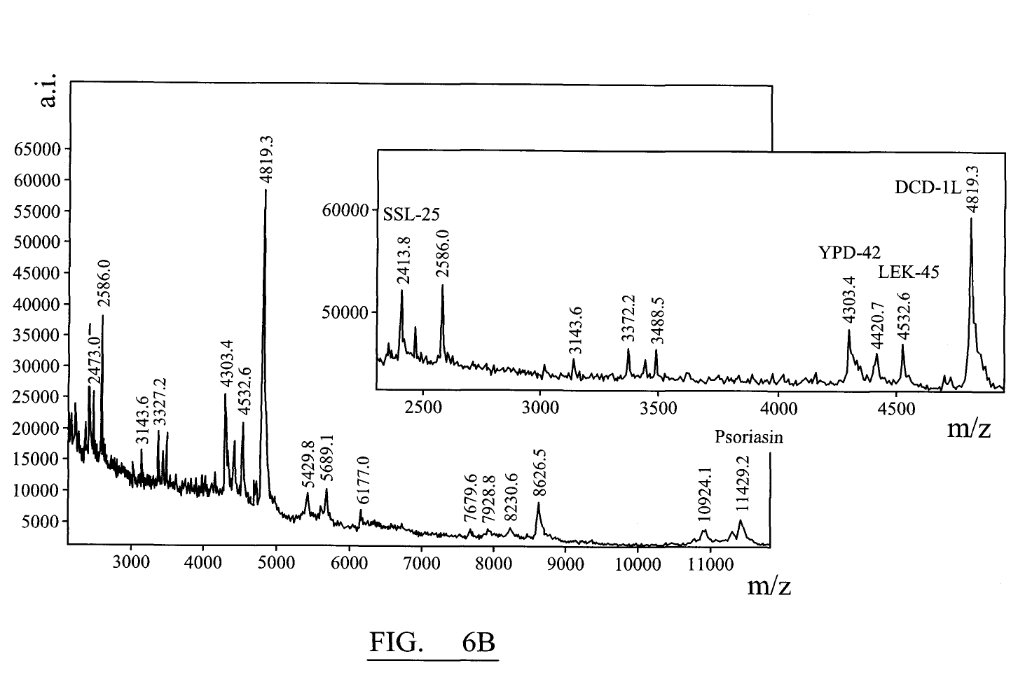

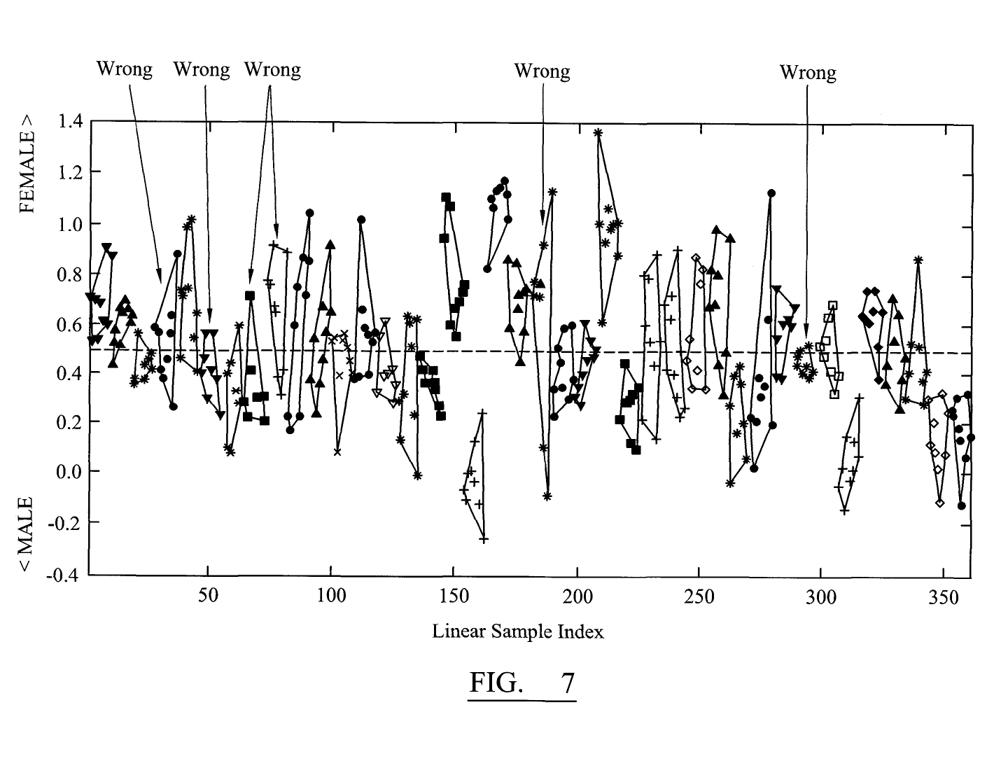

FIG. 7 are classification results and validation using an independent test set;

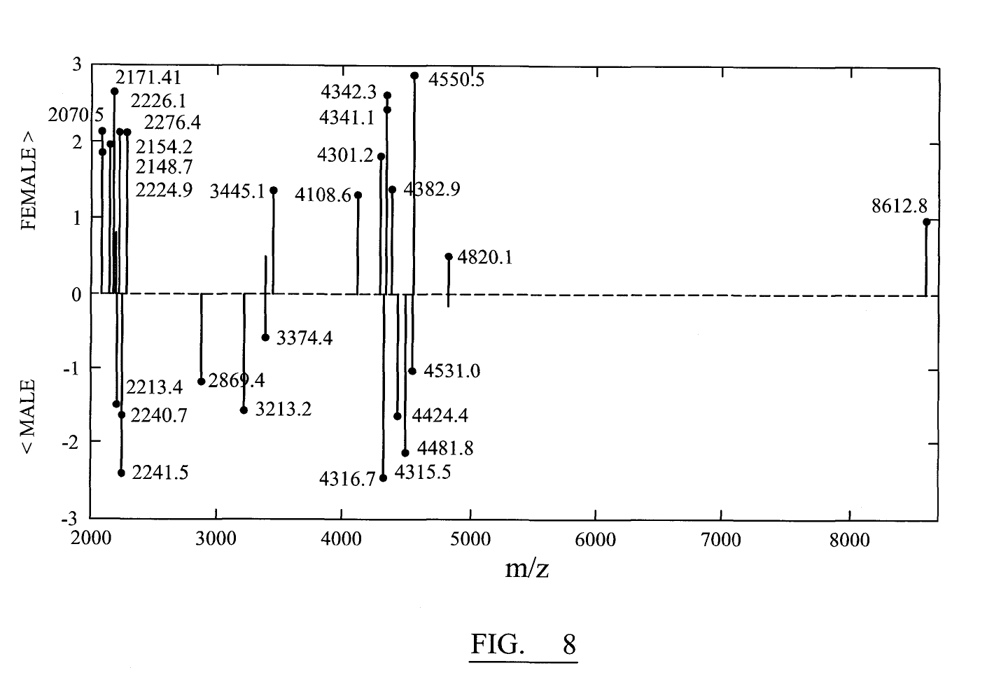

FIG. 8 is a graph of the regression vector for the final PLSDA model with 5 latent variables.

An optimised protocol was applied to analyse, in a pilot study, fingermarks from a cohort of 32 donors of which 15 were females and 17 males in the attempt to discriminate donors on the basis of gender with MALDI MS. Spectral data from this study have been classified with supervised multivariate analysis using Orthogonal Partial Least Squares Discriminant Analysis (O-PLS-DA) [J. Trygg and S. Wold, Orthogonal projections to latent structures (O-PLS), Journal of chemometrics, 16 (3) (2002) 119-128]; [J. M Fonville, S. E. Richards, R. H. Barton, C. L. Boulange, T. M. D. Ebbels, J. K. Nicholson, E. Holmes and M. E. Dumas. The evolution of partial least squares models and related Chemometric approaches in metabonomics and metabolic phenotyping, Journal of chemometrics, 24 (11-12) (2010) 363-349].

Although the pilot study gave a promising indication of feasibility of the methodology, the exiguity of the volunteers' cohort did not allow statistically significant conclusions to be drawn. Therefore in a following study, fingermarks from a cohort of 80 donors of which 40 were females and 40 males were investigated. MALDI MS spectral data from this study have been classified this time with PLS-DA for the discrimination of gender.

Results demonstrate the feasibility of this approach to potentially determine the gender of the donor from fingermarks retrieved at crime scenes and, after unsuccessful attempts to use fatty acids and more complex lipids in this context, the inventors demonstrate that endogenous peptides and small proteins can instead act as biomarkers of gender.

### Materials and Methods

### Materials

Trifluoroacetic acid (TFA), ALUGRAM® SIL G/UV₂₅₄ Pre-Coated Aluminium Sheets and α-cyano-4-hydroxycinnamic acid (α-CHCA) were obtained from Sigma-Aldrich, Poole, UK). Acetone, acetonitrile (ACN), chloroform, ethanol and denatured ethanol were purchased from Fisher Scientific (Loughborough, UK). MALDI target OPTI TOF spotless inserts were obtained from Applied Biosytems (Foster City, Ca, USA). Double sided conductive carbon tape was purchased from TAAB (Berks, UK).

### Instrumentation and Instrumental Parameters

Mass spectrometric analyses were conducted using an Applied Biosystems MALDI TOF Voyager De-STR mass spectrometer (Foster City, Ca) equipped with a 355 nm Nd-YAG solid state laser operating at a repetition rate of 20 Hz. Full scan mass spectra in the m/z range 2000-30000 were recorded in positive linear mode and 50 or 100 shots (for Gender Study A and Gender Study B respectively) were accumulated per spectrum. The accelerating voltage was set at 25,000 Volts, the grid voltage was set at 93% and the delay time was 150 ns. Preliminary calibration of the instrument was performed every 8 analyses using ion signals from a peptide mixture ranging in molecular weight from 4.8 kDa to 16 kDa, consisting of DCD-1L, insulin, apomyoglobin and cytochrome c.

### Fingermark Preparation

Eccrine fingermarks were prepared by cleansing hands with a 50% aqueous ethanol solution and placing one hand in a plastic freezer bag, secured in place with an elastic band for a period of 15 minutes. Three fingermarks were then deposited onto pre-coated aluminium sheets after removing the silica with acetone.

Ungroomed fingermarks were prepared by cleaning hands with a 50% aqueous ethanol solution and carrying on normal work activities for a period of 15 minutes before rubbing the fingertips against each other and depositing 3 fingermarks onto aluminium sheets (which were preliminarily treated to remove the silica coat).

Groomed fingermarks were prepared by cleaning the hands with a 50% ethanol wash and rubbing the fingers on the forehead, nose and chin five times to obtain a sebum-rich mark before deposition in triplicate on aluminium sheets (prepared as stated above).

Aluminium sheets were attached to MALDI spotless inserts using double sided carbon conductive tape for analysis by MALDI MS.

### Method Optimisation

### Optimisation of MALDI Matrix Composition

Matrix solution of 5 mg/ml CHCA were prepared using different ratios of ACN to TFA (50:50, 60:40, 70:30, 80:20 and 90:10). The concentration of TFA was also varied (0.1%, 0.2%, 0.3%, 0.4% and 0.5%). Fingermarks were then subjected to MALDI MS profiling and spectral intensity evaluated.

Optimisation of the Ion Abundance and Intensity from Groomed Fingermarks

Each of three test groomed fingermarks was cut in half and only one half of each was washed in either 750 μL of acetone, chloroform or denatured ethanol. After washing, five droplets (of 0.5 μL each) of a 5 mg/ml CHCA solution in 70:30 ACN/0.5% TFA were spotted on both the washed and the unwashed fingermark halves in five different areas and profiling mass spectra were acquired.

### Gender Study

For clarity, the gender study based on a cohort of 32 donors will be designated from now on as Gender Study A, whereas the study employing a cohort of 80 volunteers will be designated as Gender Study B. In both cases recruited participants were older than 20 and younger than 45 years old. Volunteers having made use of medications or drugs within the two weeks preceding the collection, were excluded from the studies. Both of the two studies were conducted under full ethical approval of the Biosciences Research Ethics Review Group (Faculty of Health and Wellbeing, Research Ethics Committee Sheffield Hallam University).

### Gender Study A—

Uungroomed fingermarks were collected as described in “Fingermark preparation” above from 32 donors (females and 17 males) in triplicate. Five 1 μL spots of a 5 mg/ml CHCA solution in 70:30 ACN/0.5% TFA were deposited on different regions of each fingermark and corresponding MALDI mass spectra profiles were acquired.

### Gender Study B—

Ungroomed fingermarks were collected as described in “Fingermark preparation” above from 80 donors (40 females and 40 males) in triplicate. Three 0.5 μL spots of a 5 mg/mL α-CHCA solution in 25:25:50 Ethanol/ACN/TFA 0.5% were deposited close to the centre of each mark, on an imaginary line crossing the centre of the impression; corresponding MALDI mass spectra profiles were acquired, resulting in 9 spectra per donor.

### Statistical Analysis

Both of the two Gender studies (A and B) were performed on ungroomed fingermarks. Gender Study A: Fingermark mass spectral profiles were acquired in three replicate fingermarks that were obtained for each donor; 5 spectra were acquired from each replicate fingermark. The mass spectra were converted into text files and submitted to SpecAlign software [J. W. H. Wong, G. Cagney and H. M. Cartwright, SpecAlign—processing and alignment of mass spectra Datasets, Bioinformatics, 21 (9) (2005) 2088-2090] for pre-processing. The pre-processing stage consisted of baseline correction, noise removal, normalisation against the total ion count (TIC) and spectral alignment using PAFFT correlation. Spectra that were of a poor quality were subsequently removed, and the remaining spectra for all donors were imported into MarkerView™ 1.2 software (Applied Biosystems/MDS Sciex, Concord, Canada), with a mass tolerance of 10.0 a.m.u. (i.e. the bin size into which the data was grouped), and a minimal signal count of 0.1. For the ungroomed data, this resulted in 1619 m/z variables. Data were then imported and analysed in Matlab (Natick, Mass., USA).

The ungroomed data [455 spectra×1619 m/z variables] were normalised to the median peak intensity [J M Fonville, C. Carter, O. Cloarec, J. K. Nicholson, J. C. Lindon, J Bunch and E. Holmes, Robust data processing and normalization strategy for MALDI mass spectrometric imaging, Analytical chemistry, 84 (3) (2012) 1301-1319]. The data were randomly divided into a training set (spectra from 24 donors, m=13, f=11, [340×749]) and test set (8 donors; m=4 and f=4, [115×749]). The training set data were mean-centered and an O-PLS-DA model with 1 predictive component was built using the algorithm described in Trygg et al. [J. Trygg and S. Wold, Orthogonal projections to latent structures (O-PLS), Journal of chemometrics, 16 (3) (2002) 119-128]. A class-balanced cross-validation where replicate spectra from 4 donors were removed was performed on the training data (O-PLS-DA with 6 cross-validation rounds), and optimal prediction was found for 3 orthogonal components (the model used 3 filtering factors and then 1 predictive factor, for a total of 4 components).

Subsequently the data from the test set were predicted and prediction performance was evaluated. The predictive accuracy was defined as the total number of correctly predicted genders divided by the total number of evaluated spectra.

### Gender Study B:

Fingermark mass spectral profiles were acquired in three replicate fingermarks that were obtained for each donor; 3 spectra were acquired for each replicate fingermark. The mass spectra were converted into text files and submitted to SpecAlign software for pre-processing. The pre-processing stage, in this case, consisted only of baseline correction to a factor of 20 and spectral alignment using PAFFT (Peak alignment by Fast Fourier Transform). Spectra were converted in CSV files and imported and analysed in Matlab (Natick, Mass., USA).

First, the 100 data spectral variables on each end of the spectrum were deleted as these regions contain mainly artefacts resulting from the spectral alignment and baseline correction performed through SpecAlign. Consequently, the data were divided into two halves by randomly selecting 20 males and 20 females as a training set and leaving the other 40 donors (m=20, f=20 too) as a test set for validation. This resulted in two data matrices containing 360 spectra by 12047 m/z values. The training set data were used to build the PLS-DA model (PLS_Toolbox, Version 6.2.1, Eigenvector Research, Inc., Wenatchee, Wash., USA) and internal cross validation, leaving out iteratively all spectra from each donor once (40 cross validation rounds) was used to establish that four latent variables were necessary for an accurate and stable prediction model. Subsequently the data from the test set were used with the previously built PLS-DA model and the predictive accuracy assessed by assigning each donor to their corresponding gender that the majority of its spectra were classified to by the model and comparing that with the donor's actual gender. From the cross validation result it was clear that the MS data contains a large amount of variation unrelated to the gender classification, hence a selection of variables based on the Variable Importance for Projection (VIP) score was performed to lead to a spectrally more concise model using five latent variables [I. G. Chong, C. H. Jun, Performance of some variable selection methods when multicollinearity is present, Chemometrics and Intelligent Laboratory Systems, 78 (2005) 703-11221].

### Results and Discussion

Experiments were performed to determine the MALDI matrix composition yielding the maximum ion abundance and intensity for peptides and small proteins to be detected from fingermarks. Eccrine sweat contains many antimicrobial peptides and small proteins including species such as Dermcidin (DCD), different processed DCD-derived C-terminal peptides such as (DCD-1L), and (DCD-1), human cathelicidin LL-37, human β-defensin (HBD) 2, and HBD-3 and psoriasin [S. Rieg, H Steffen, S. Seeber, A. Humeny, H. Kalbacher, K Dietz, C. Garbe, and B. Schittek, Deficiency of Dermcidin-Derived Antimicrobial Peptides in Sweat of Patients with Atopic Dermatitis Correlates with an Impaired Innate Defense of Human Skin In Vivo, The Journal of Immunology, 174: (2005) 8003-8010]; [B. Schittek, M Paulmann, I. Senyürek and H Steffen, The Role of Antimicrobial Peptides in Human Skin and in Skin Infectious, Diseases Infectious Disorders—Drug Targets, 8, (3) (2008), 135-143]. As eccrine fingermarks would be a reflection of eccrine sweat, the inventors hypothesised that it should be possible to detect these peptides and proteins directly from them. However, eccrine fingermarks are the least realistic type of fingermark found at crime scenes (S Bleay, personal communication); additionally, many of the above species are constitutively expressed in the human dermis and then transported through the sweat [S. Rieg, H. Steffen, S. Seeber, A. Humeny, H. Kalbacher, K Dietz, C. Garbe, and B. Schittek, Deficiency of Dermcidin-Derived Antimicrobial Peptides in Sweat of Patients with Atopic Dermatitis Correlates with an Impaired Innate Defense of Human Skin In Vivo, The Journal of Immunology, 174: (2005) 8003-8010]. This would suggest that these species are associated with sebaceous material as well; the concentration of these species in the sebaceous gland is not known, but Lee and collaborators [D.-Y Lee, K Yamasaki, J. Rudsil, C. C. Zouboulis, G. T. Park, J.-M Yang and R. L. Gallo, Sebocytes Express Functional Cathelicidin Antimicrobial Peptides and Can Act to Kill Propionibacterium Acnes Journal of Investigative Dermatology 128 (2008), 1863-1866] report findings supporting the conclusion that the sebaceous gland contributes to epithelial defence by the release of multiple antimicrobial molecules to the skin surface.

Ungroomed fingermarks consist predominantly of eccrine secretions, but may also contain some sebaceous content and are the type of fingermark most likely to be encountered at real crime scenes. Therefore, in the first instance, it was decided to optimise the MALDI matrix on the least peptides and protein containing type of fingermarks but also the type that would be likely to be found at crime scenes and therefore ungroomed fingermarks were chosen as test samples. Several matrices, matrices combinations (along with solvent compositions) were evaluated including α-CHCA, sinapininc acid, DHB and dihydroxyacetophenone at different concentrations. Differently from Rieg and collaborators [S. Rieg, S. Seeber, H Steffen, A. Humeny, H Kalbacher, S. Stevanovic, A. Kimura, C. Garbe, B. Schittek, Generation of multiple stable dermcidin-derived antimicrobial peptides in sweat of different body sites, Journal Investigative Dermatology 126 (2) (2006) 354-65] and Baechle and collaborators [D. Baechle, T. Flad, A. Cansier, H Steffen, B. Schittek, J. Tolson, T Herrmann, H Dihazi, A. Beck, G. A. Mueller, M Mueller, S. Stevanovic, C. Garbe, C. A. Mueller, H Kalbacher, Cathepsin D is present in human eccrine sweat and involved in the postsecretory processing of the antimicrobial peptide DCD-1L, Journal of Biological Chemistry 281(9) (2006) 5406-15] in their SELDI and MALDI MS analyses respectively on sweat, in the present method and system, the best matrix was found to be α-CHCA at a concentration of 5 mg/mL (data not shown). The composition of the solvent solution was optimised by preparing a 5 mg/mL solution of α-CHCA in 70:30 Acetonitrile/TFA and varying the percentage of TFA (0.1%, 0.2%, 0.3%, 0.4% or 0.5%) required to detect the richest peptides and proteins ion population and the highest ion intensities. Data showed that best results were obtained using TFA 0.5% (as shown in FIG. 1A to 1E). The ion signal intensities were observed to be overall higher using TFA at a percentage of 0.5% v/v. Following the optimisation of the TFA concentration, the optimum ratio of ACN to TFA was also investigated (50:50, 60:40, 70:30, 80:20 and 90:10) keeping the concentration of TFA fixed at 0.5% and the best solvent composition was 70/30 Acetonitrile/TFA 0.5% (as shown in FIG. 2A to 2E). Following optimisation of the matrix and matrix composition as well as of the instrumental parameters, eccrine and groomed fingermarks were also evaluated in terms of the ion abundance and intensity and against each other and against the ungroomed fingermarks. Eccrine fingermarks consist of the secretions of the eccrine glands only; they were obtained producing excess sweating of the hand as described. Groomed fingermarks instead are obtained by wiping the fingertips across areas such as the face and neck which are known to contain an abundance of sebaceous glands, thereby artificially loading the fingermarks with sebaceous material. The mass spectra acquired from the eccrine fingermarks showed no signal in the m/z region investigated as shown in FIG. 3A. This is probably due to excess salts (naturally present in sweat) in the fingermark deposit which exerted an ion suppression effect, in agreement with what was hypothesised by Flad and colleagues [T Flad, R. Bogumil, J. Tolson, B. Schittek, C. Garbec, M Deega, C. A. Muellera, H. Kalbacher, Detection of dermcidin-derived peptides in sweat by ProteinChipR Technology, Journal of Immunological Methods 270 (2002) 53-62]. With regards to groomed fingermarks, while possibly increasing the content of the relevant peptides and proteins species, groomed fingermarks also contained an increased amount of lipids. The resulting mass spectra of groomed fingermarks were in fact dominated by lipid ion signal (data not shown). Generally lipids have a very high ionisation yield and by preferentially absorbing the energy transferred by the matrix over other biomolecules, they often cause ion suppression of biomolecules such as peptides and proteins [S. A. Schwartz, M. L. Reyzer and R. M. Caprioli, Direct tissue analysis using matrix-assisted laser desorption/ionization mass spectrometry: practical aspects of sample preparation, Journal of Mass Spectrometry, 38: (2003) 699-708]. Many examples of how the use of different organic solvents help removal of lipids, thus increasing the ionisation yield of other species, have been reported [S. A. Schwartz, M. L. Reyzer and R. M. Caprioli, Direct tissue analysis using matrix-assisted laser desorption/ionization mass spectrometry: practical aspects of sample preparation, Journal of Mass Spectrometry, 38: (2003) 699-708]; [R. Lemaire, M Wisztorski, A. Desmons, J C. Tabet, R. Day, M Salzet, and I. Fournier, MALDI-MS Direct Tissue Analysis of Proteins: Improving Signal Sensitivity Using Organic Treatments Analyical Chemistry 78, (2006), 7145-7153]; [E. H. Seeley, S. R. Oppenheimer, D. Mi, P. Chaurand, and R. M. Caprioli Enhancement of Protein Sensitivity for MALDI Imaging Mass Spectrometry After Chemical Treatment of Tissue Sections, Journal of American Society for Mass Spectrometry 19 (8), (2008) 1069-77].

In the present work, three organic solvents were used to wash groomed fingermarks and their impact, as a direct consequence of lipids removal, on the ion abundance was evaluated. FIG. 3A is an example of an eccrine fingermark mass spectrum where no signal was detected in the m/z range between 2500-15000. FIG. 3B shows examples of mass spectra from groomed fingermarks that have been analysed after washing with (i) acetone, (ii) chloroform and (iii) denatured ethanol with the latter proving to be the best solvent in terms of ion population and ion intensity. FIG. 3C is an example of an ungroomed fingermark where fewer but higher resolution and generally higher intensity ion signals could be detected.

Groomed fingermarks which were washed with acetone displayed the lowest signal ion intensities: the ion intensity improved by using chloroform whereas denatured ethanol provided the best mass spectrum profile in terms of ion abundance and population (as shown in FIG. 3B, panels i, ii and iii respectively). The comparison between eccrine and ungroomed fingermark mass spectral profiles (FIGS. 3A and 3C) is straightforward and leads to discarding eccrine fingermarks as viable test samples, however, the comparison between groomed and ungroomed fingermarks is not and enabled some observations to be made. Given the sebaceous nature of these particular peptides and proteins, the groomed fingermarks, especially after the wash in ethanol, exhibited a much higher ion population than that yielded by ungroomed fingermarks. However, the resolution and the S/N in the groomed fingermarks mass spectra were worse. Additionally, groomed fingermarks yielded much poorer spectra without a preliminary wash, which also adds to the sample preparation time. That being considered and given that ungroomed fingermarks are more likely to be found at crime scenes than groomed ones, the Gender Study A (pilot study with a cohort of 32 donors) was conducted by collecting and analysing ungroomed fingermarks.

Multivariate statistical analysis using O-PLS-DA [J. Trygg and S. Wold, Orthogonal projections to latent structures (O-PLS), Journal of chemometrics, 16 (3) (2002) 119-128] which provides supervised classification with improved interpretation compared to other PLS models [J. M Fonville, S. E. Richards, R. H. Barton, C L. Boulange, T. M. D. Ebbels, J. K. Nicholson, E. Holmes and M. E. Dumas. The evolution of partial least squares models and related Chemometric approaches in metabonomics and metabolic phenotyping, Journal of chemometrics, 24 (11-12) (2010) 363-349], was applied to the mass spectral profiles obtained from the ungroomed fingermarks. After removal of low quality spectra, data from 32 donors (m=17, f=15) remained and these were divided into sets as described: the training set (reference data), used to build a classification model, and the test set (sample data), which was used to validate the classification model. The confusion matrix for both the training and the test set is reported in table 1 and shows a prediction accuracy of 67% for the cross-validation of the training set, and an accuracy of 68% for the test set, suggesting the potential of gender discrimination by fingermarks.

TABLE 1
Confusion Matrix for the Training Set (I) and the Test Set (II).
Each column of the table represents the instances in a predicted
gender, while each row represents the instances in an actual gender.

| | Predicted Male | Predicted Female | Total |
|---|---|---|---|
| I | | | |
| Actual Male | 112 | 74 | 186 |
| Actual Female | 38 | 116 | 154 |
| Total | 150 | 190 | 340 |
| II | | | |
| Actual Male | 40 | 15 | 55 |
| Actual Female | 22 | 38 | 60 |
| Total | 62 | 53 | 115 |

Results of the predictions for the cross-validation during the model building, based on the training set (based on 340 spectra), and for the final model which was validated with the test set, are reported in a boxplot shown in FIG. 4. The model was trained with −1 for male and +1 for female samples in the discriminant analysis. The best prediction would be achieved if males were predicted to be −1, and females as +1, and the classification threshold (0) is shown as a line. The box plot shows the lower, median and upper quartile, and distributions in the tails are represented with whiskers and plusses. The smaller the overlap between the boxes for the two genders, the better the sensitivity and specificity of the method. The results for the test set (based on 115 spectra) are displayed in a similar manner, and indicate that the distribution of the value predicted by O-PLS-DA differs between the females and males. This suggests that putative information of gender can be extracted from MALDI MS detection peptides and proteins in fingermarks followed by multivariate statistical analysis.

A loading plot for this O-PLS model is shown in FIG. 5A, which demonstrates the molecular profiles differentiating the genders. Peaks with a higher contribution to the class separation are indicated by arrows. The average peak intensity across all spectra is represented by the height of the bar, and the direction displays the gender in which this species was found to be increased. Additional panels (FIGS. 5B to 5G) display magnified views and species considered important for gender prediction have been labelled with arrows. Peaks that were related to females point upwards, whereas m/z values that were related to males point downwards.

In order to confirm the results from this pilot study, a second study involving a much larger cohort of donors was undertaken (Gender Study B). Taking stock from Gender Study A, a few protocol steps were altered in Gender Study B to improve ion signal reproducibility and to enhance robustness of the statistical method, thus leading to more reliable results. In particular it was found that, changing the matrix solvent composition to 25:25:50 Ethanol/Acetonitrile/0.5% TFA_{aq}, improved homogeneity of matrix-analyte, co-crystals thus positively impacting on intra-donor spectra reproducibility (data not shown). Also, spectra were only baseline-corrected and aligned prior to importing into Matlab in order to minimise the amount of pre-processing step outside Matlab control. Finally, PLS-DA was used instead of O-PLS DA; indeed O-PLS-DA was found to be more prone to data over-fitting and less transparent than PLS-DA with no real advantage over PLS-DA. These findings were in agreement with the review on these two methodologies by Tapp and Kemsley [H. S. Tapp, E. K Kemsley, Notes on the practical utility of OPLS, Trends in Analytical Chemistry, 11: (2009) 1322-1327]. The classification based on the first PLS-DA model of the left out donors during the cross validation resulted in a correct gender prediction for 18 (out of 20) females and 20 males (90% and 100% accuracy respectively). The prediction for the independent test set gave an accuracy of 18 and 13 correct predictions for the 20 female and 20 male donors, resulting in an accuracy of 90% and 65% respectively.

In order to decrease the influence of variance not linked to gender, the modelling exercise was repeated but now only including those spectral variables with a VIP score of 10 or more. This resulted in a selection of only 199 spectral variables, on which the same data analysis methodology was performed (PLS-DA with cross validation on training set and subsequent prediction of independent test set). The resulting final model predicted 19 (out of 20) for both genders correctly during cross validation and 17 for both genders correctly for the validation test set (accuracy of 95% 85% respectively). The prediction for each spectrum of the test set is depicted in FIG. 7. Spectra from each donor have the same plotted symbol and are grouped together with an outline. Prediction above the threshold line (0.5 y axis) results in a predicted female gender, and below the threshold line is male gender prediction. Donors labelled with “wrong” have more than half of their spectra assigned to the opposite gender.

These results give a strong indication that there is in principle the potential to discriminate between males and females with the available data, suggesting that information on gender could be extracted from MALDI MS detection of peptides in fingermarks followed by multivariate statistical analysis.

PLS-DA calculates for each variable a regression coefficient that represents the respective variables' contributions to the prediction of the gender. The regression coefficients vector for the final model (based on 199 VIP selected m/z values) is given in FIG. 8. Peaks with high values have been labelled and would be promising candidates for biochemical interpretation of the classification model. In particular, peaks that appear on the top half of the regression vector plot are important for the discrimination of the female gender and peaks appearing on the bottom half of the same plot are discriminant for male gender.

Various antimicrobial peptides and small proteins have been putatively detected within the ungroomed fingermarks of a large number of donors. These species have been putatively identified (including DCD 1 DCD 1L, LEK-24, YDP-42 and psoriasin) on the basis of their m/z and in consideration of the attribution previously made by others from the examination of sweat [S. Rieg, H Steffen, S. Seeber, A. Humeny, H Kalbacher, K Dietz, C. Garbe, and B. Schittek, Deficiency of Dermcidin-Derived Antimicrobial Peptides in Sweat of Patients with Atopic Dermatitis Correlates with an Impaired Innate Defense of Human Skin In Vivo, The Journal of Immunology, 174: (2005) 8003-8010]; [B. Schittek, M Paulmann, I Senyurek and H Steffen, The Role of Antimicrobial Peptides in Human Skin and in Skin Infectious, Diseases Infectious Disorders—Drug Targets, 8, (3) (2008), 135-143]; [D.-Y Lee, K Yamasaki, J. Rudsil, C. C. Zouboulis, G. T. Park, J.-M Yang and R. L. Gallo, Sebocytes Express Functional Cathelicidin Antimicrobial Peptides and Can Act to Kill Propionibacterium Acnes Journal of Investigative Dermatology 128 (2008), 1863-1866]; [S. Rieg, S. Seeber, H Steffen, A. Humeny, H Kalbacher, S. Stevanovic, A. Kimura, C. Garbe, B. Schittek, Generation of multiple stable dermcidin-derived antimicrobial peptides in sweat of different body sites, Journal Investigative Dermatology 126 (2) (2006) 354-65]; [D. Baechle, T Flad, A. Cansier, H Steffen, B. Schittek, J Tolson, T Herrmann, H. Dihazi, A. Beck, G. A. Mueller, M Mueller, S. Stevanovic, C. Garbe, C. A. Mueller, H. Kalbacher, Cathepsin D is present in human eccrine sweat and involved in the postsecretory processing of the antimicrobial peptide DCD-1L, Journal of Biological Chemistry 281(9) (2006) 5406-15], as shown in FIGS. 6A and 6B. However, in the Gender Study A, these biomolecules appear less important in the molecular profile for gender discrimination according to our O-PLS-DA classification model; whereas the presence of β-defensin 2 (experimental average m/z 3375.9, theoretical average m/z 3378.0) is suspected, the other species remain at present unknown and an in situ proteomic approach will be required to ascertain their identity.

In Gender Study B, robustness and reliability of the methodology has been much improved. The spectral interpretation of the PLS-DA model via regression and VIP score vectors gives an entry point for the molecular interpretation of the discriminating gender differences found by the statistical model. In our more robust model for the Gender Study B, putative β-defensin 2, discriminating the male gender still seems to be present. Additionally, the species at m/z 2869, 4531 and 4820 reported in FIG. 8, that in the calibrated spectra appear at m/z 2870.2, 4532.2 and 4819.5, and are tentatively identified as SSL-29 (theoretical m/z 2870.3), LEK-45 (theoretical m/z 4532.2) and DCD-1L (theoretical m/z 4819.5) respectively, appear to be important in the molecular profile for the detection of the male gender (DCD-1L) and the female gender (SSL-29 and LEK-45). These and other peptide species contribute to a statistical model that appears promising for the determination of gender of fingermarks. However, before engaging the process of identification of the most discriminatory m/z values via in situ proteomic strategies, further studies are needed to confirm these biomarkers and potentially detect additional biomarkers (e.g. no restriction to participants, use of “natural fingermarks).

The present invention, using multivariate modelling of mass spectrometric profiles of fingermarks composition, is therefore useful for the further extraction of information about a donor of a biological deposit leading to possible characterisation of the donor. The present invention is applicable to a variety of specific applications and in particular gender discrimination based on fingermark analysis. In particular, the mass spectrometric analysis (including sample preparation, analysis, processing and inputting of data into the statistical model) takes no longer than twenty minutes and the prediction of new spectra, using an established and validated multivariate model, takes less than a second, thus providing the investigators with information on the donor's gender in a short time frame. The value of the information and the speed at which this is obtained would have a considerable impact on forensic investigations. Additionally, this approach can be expected to be equally easily applied to study other features of the biological deposit composition for discrimination purposes such as age and nutritional habits for example.

1. A method of categorising a human according to predetermined categories using Matrix Assisted Laser Desorption Ionisation Mass Spectrometry (MALDI-MS, the method comprising:
obtaining a biological deposit from a human;
analysing the deposit using MALDI-MS to obtain sample spectral data in the m/z range 2,000 to 30,000;
referencing reference spectral data in a library in the m/z range 2,000 to 30,000 or characteristics based on said reference spectral data obtained from biological deposits from humans that had been analysed using MALDI-MS and categorised into the pre-determined category;
comparing characteristics of the sample spectral data with the reference spectral data or characteristics thereon; and
characterising the human into at least one of the predetermined categories.

2. The method as claimed in claim 1 wherein the biological deposit comprises a fingermark.

3. The method as claimed in claim 2 wherein the fingermark is a fingermark comprising compounds from the eccrine and/or sebaceous glands.

4. The method as claimed in claim 3 wherein the fingermark is an ungroomed fingermark.

5. The method as claimed in claim 1 wherein the sample spectral data in the m/z range 2,000 to 30,000 comprises peptides, proteins and/or truncated proteins.

6. The method a claimed in claim 5 wherein the peptides, proteins and/or truncated proteins are endogenous to the human.

7. The method as claimed in claim 5 wherein the peptides are associated with a sweat gland of the human.

8. The method as claimed in claim 1 wherein the step of analysing the deposit comprises obtaining sample spectral data of peptides in the m/z range 2,000 to 5,000.

9. The method as claimed in claim 1 wherein the step of analysing the deposit comprises obtaining sample spectral data of proteins in the m/z range 5,000 to 30,000.

10. The method as claimed in claim 1 wherein said characteristics comprise any one or a combination of the following set of:
individual intensities of spectral peaks of the sample spectral data;
a ratio of intensities of spectral peaks of the sample spectral data.

11. The method as claimed in claim 1 wherein the pre-determined categories comprise any one or a combination of the following set of:
gender;
ethnicity;
age;
health status;
dietary habit;
humans who smoke;
humans that drink excessive alcohol;
pregnant females.

12. A method of preparing reference spectral data using Matrix Assisted Laser Desorption Ionisation Mass Spectrometry (MALDI-MSS for use in the categorisation of a human according to pre-determined categories, the method comprising:
categorising a plurality of humans into at least one category of a plurality of predetermined categories based on personal characteristics of each of the humans;
obtaining a biological deposit from each of the humans;
analysing the deposit from each of the humans using MALDI-MS to obtain spectral data in the m/z range 2,000 to 30,000; and
associating characteristics of the spectral data for each human with the personal characteristics of the human to generate reference spectral data for use in the comparison with sample spectral data in the m/z range 2,000 to 30,000 obtained from a biological deposit of a non-categorised human.

13. A method of categorising a human according to pre-determined categories using MALDI-MS, the method comprising:
obtaining a biological deposit from a human;
analysing the deposit using MALDI-MS to obtain sample spectral data in the m/z range 2,000 to 30,000;
referencing the reference spectral data according to claim 12; and
comparing characteristics of the sample spectral data with the reference spectral data or characteristics thereon to categorise the human into at least one of pre-determined categories.

14. Apparatus for categorising a human according to pre-determined categories using Matrix Assisted Laser Desorption Ionisation Mass Spectrometry (MALDI-MS), the apparatus comprising:
a sample holder for holding a biological deposit from a human;
a MALDI-MS mass spectrometer to analyse the deposit using MALDI-MS to obtain sample spectral data in the m/z range 2,000 to 30,000;
a storage utility containing reference spectral data in the m/z range 2,000 to 30,000 or data based on said reference spectral data obtained from biological deposits from humans that have been analysed using MALDI-MS and categorised into the predetermined categories;
a processor to process a comparison of the characteristics of the sample spectral data with the reference spectral data or data based thereon; and
a user interface to allow a user to interrogate the sample spectral data, the reference spectral data and/or the data resulting from the comparison of the sample and reference spectral data.

15. The method as claimed in claim 6 wherein the peptides are associated with a sweat gland of the human.

16. The method as claimed in claim 8 wherein the step of analysing the deposit comprises obtaining sample spectral data of proteins in the m/z range 5,000 to 30,000.

17. The method as claimed in claim 10 wherein the pre-determined categories comprise any one or a combination of the following set of:
gender;
ethnicity;
age;
health status;
dietary habit;
humans who smoke;
humans that drink excessive alcohol;
pregnant females.
